(19) United States
(12) Patent Application Publication
(10) Pub. No.: US 2013/0335072 A1
(43) Pub. Date: Dec. 19, 2013

(54) STEERING TORQUE ANGLE SENSOR HAVING A PROCESSOR AND A MAGNETO-RESISTIVE ELEMENT CONFIGURED IN A MONOLITHIC ARCHITECTURE

(71) Applicant: Wolfram Malzfeldt, Oakland Township, MI (US)

(72) Inventor: Wolfram Malzfeldt, Oakland Township, MI (US)

(21) Appl. No.: 13/566,022

(22) Filed: Aug. 3, 2012

Related U.S. Application Data
(60) Provisional application No. 61/660,491, filed on Jun. 15, 2012.

(51) Int. Cl. G01B 7/30

(52) U.S. Cl. 324/207.21

(57) ABSTRACT

An electronic device for measuring a magnetic field angle within a vehicle steering assembly. The electronic device includes a semiconductor die having a perimeter, a magneto-resistive sensing element formed in the die and located near the perimeter of the semiconductor die, and a processing circuit formed in the die. The processing circuit is electrically connected to the magneto-resistive sensing element and is configured to generate a signal indicative of at least one of magnetic field angle and a steering torque. A non-conductive material encapsulates the semiconductor die. Electrical connectors are electrically connected to the die and pass through the non-conductive material encapsulating the semiconductor die. The electrical connectors are configured to be electrically connected to a printed circuit board. The semiconductor die is located near the perimeter of the package to position the magneto-resistive sensing element near the perimeter of the package.

### RELATED APPLICATIONS

The present application claims priority to U.S. Provisional Patent Application No. 61/660,491 filed Jun. 15, 2012, the entire content of which is hereby incorporated by reference.

### BACKGROUND

The present invention relates to sensors used in vehicle steering systems to detect the steering input of a driver. In particular, the invention relates to vehicle steering system sensors that are designed to detect the change in an angle of a magnetic field.

Sensors designed to detect movement of rotating components are, in general, well-known. For example, Hall-effect sensors may be used to sense the speed and direction of rotation of shafts and wheels. Sensors capable of sensing steering input in passenger and similar vehicles are also generally known. For example, in a steering system that has 1) an input shaft (connected, for example, to a steering wheel), 2) an output shaft (connected, for example, to a rack or other element that is used to move or steer wheels of a vehicle), and 3) a compliant shaft or torsion bar that connects the two shafts, it is possible to sense changes in a magnetic angle and determine an input torque. In particular, a magnet is placed on one shaft and a magnetic sensing element (such as a magneto-resistive sensing element) is fitted on the other. The torsion bar has a known spring constant or torsional rigidity. Rotational movement of the input shaft with respect to the output shaft produces a relative angular displacement between the magnet and the magnetic sensing element. The angular displacement is then measured using known magnetic principles. In particular, the angular displacement is proportional to the torque exerted on the input shaft. Thus, steering torque can be derived from information provided by the magnetic sensing element.

### SUMMARY

Although sensors capable of providing information regarding steering torque are available, they are not fully satisfactory. In many conventional designs, multiple devices must be used to create a sensor that is capable of both sensing changes in magnetic field angle and generating an output indicative of the input torque. For example, sensors known to the inventors include a magnetic sensing element (for example, a circuit designed by individuals with expertise in magnetic sensing) and a processor (for example, an application specific integrated circuit designed by individuals with expertise in semiconductor and integrated circuit manufacturing). The two devices are mounted on and wired bonded to a circuit board and then connected to one another by conductive traces.

Relatively recently, packaged integrated circuits have been built that incorporate a processing component and a magnetic sensing element in one package. However, these devices often use Hall-effect sensors. Generally, Hall-effect sensors are capable of measuring only the magnitude of a magnetic field. As a consequence, multiple Hall-effect sensors must be used when attempting to measure the angle of a magnetic field. Therefore, available integrated circuits generally include at least two Hall-effect sensors and these Hall-effect sensors usually comprise multiple Hall-effect sensing elements. In addition, known single package devices usually place the Hall-effect sensing elements in a central and symmetric position of the package.

In contrast to these current designs, embodiments of the present invention provide, among other things, a steering torque angle sensor that includes a processor (such as an application specific integrated circuit (“ASIC”)) and a magneto-resistive (“MR”) sensing element. The ASIC and the MR sensing element are part of a single semiconductor die (i.e., the ASIC and the MR sensing element form a monolithic device). The die has an active perimeter and the MR sensing element is located approximately co-planar with the active perimeter of the die. Preferably, the die is connected through wire bonds to one or more electrical connectors (e.g., a lead frame). The connectors are connected to the die, and the connectors and die are encapsulated in an insulating material (such as plastic) or “packaged” to form an integrated device that can be surface-mounted on a printed circuit board. The die is positioned near a perimeter of the integrated device to position the MR sensing element close to a magnet located proximate to the integrated device. In some embodiments, the MR sensing element is positioned within the integrated device to be positioned within a saturated magnetic field (e.g., 25 kA/m) generated by the magnet.

In another embodiment, the invention provides an electronic device for measuring magnetic field angle within a vehicle steering assembly. The electronic device includes a semiconductor die having a perimeter. A magneto-resistive sensing element is formed in the die and located near the perimeter of the semiconductor die. A processing circuit is also formed in the die. The processing circuit is electrically connected to the magneto-resistive sensing element and is configured to generate a signal indicative of at least one of magnetic field angle and a steering torque. A non-conductive material encapsulates the semiconductor die. Electrical connectors are electrically connected to the die and pass through the non-conductive material encapsulating the semiconductor die. The electrical connectors are configured to be electrically connected to a printed circuit board.

In yet another embodiment, the invention provides a sensor assembly for measuring the relative angle between first and second shafts of a vehicle steering assembly. The sensor assembly includes a magnet coupled to the first shaft and an electronic device as described in the previous paragraph. The electronic device is coupled to the second shaft such that the magneto-resistive sensing element included in the electronic device is proximate to the magnet.

In still another embodiment, the invention provides a sensor assembly for measuring a magnetic field angle within a vehicle steering assembly. The sensor assembly includes a first electronic device as described in paragraph [0007] and a second electronic device as described in paragraph [0007]. The second electronic device is positioned adjacent the first electronic device on the printed circuit board.

Other aspects of the invention will become apparent by consideration of the detailed description and accompanying drawings.

### BRIEF DESCRIPTION OF THE DRAWINGS

FIG. 1 is a perspective view of a vehicle steering assembly including a torque angle sensor assembly for measuring steering shaft torque.

FIG. 2 is a front perspective view of the torque angle sensor assembly of FIG. 1.

FIG. 3a schematically illustrates the torque angle sensor assembly of FIG. 1.

FIG. 3b schematically illustrates an electronic device included in the torque angle assembly of FIG. 1 according to one embodiment of the invention.

FIG. 3c schematically illustrates an electronic device included in the torque angle assembly of FIG. 1 according to another embodiment of the invention.

FIG. 3d is a side view of the electronic device of FIG. 3b.

FIG. 3e is an end view of the electronic device of FIG. 3b.

FIG. 4 schematically illustrates a magnetic field generated by the magnet of the torque angle sensor assembly of FIG. 1.

FIG. 5 schematically illustrates an alternative embodiment of the invention in the form of an electronic device having two magnetic sensing elements.

FIG. 6 schematically illustrates a configuration for a torque angle sensor assembly where two electronic devices are positioned in proximity to a magnet.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

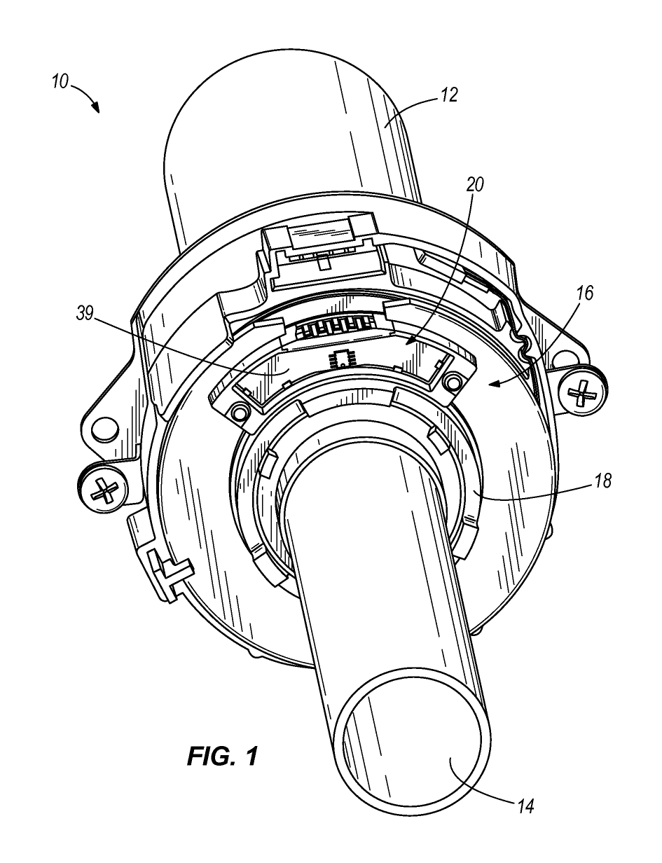

FIG. 1 illustrates a vehicle steering assembly 10. The assembly 10 includes an input shaft 12 and an output shaft 14. The input shaft 12 connects to a steering wheel (not shown) and the output shaft 14 connects to a rack or gear box (not shown) used to move or steer wheels of the vehicle. The input shaft 12 is coupled to the output shaft 14 by a torsion bar (not shown). The torsion bar is coaxially aligned with the shafts 12 and 14 and has a known torsional rigidity or spring constant. The torsion bar transmits load from the input shaft 12 to the output shaft 14. In particular, the torsion bar flexes or twists to allow relative angular displacement of the input shaft 12 relative to the output shaft 14 in proportion to the amount of torque applied to the input shaft 12. The difference in relative rotational displace of the input shaft 12 to the output shaft 14 is proportional to the magnitude of torque being applied to the steering wheel.

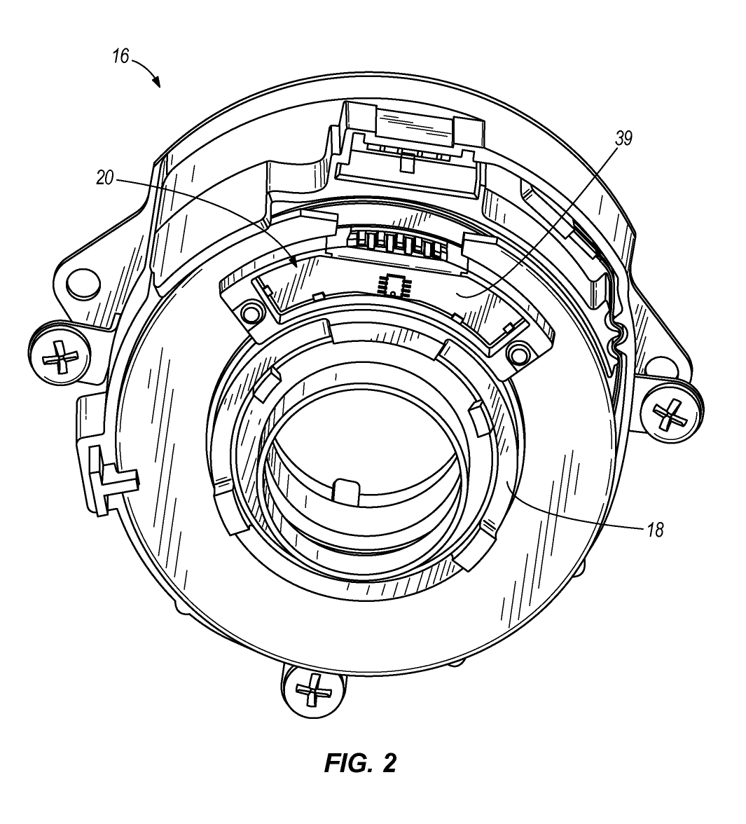

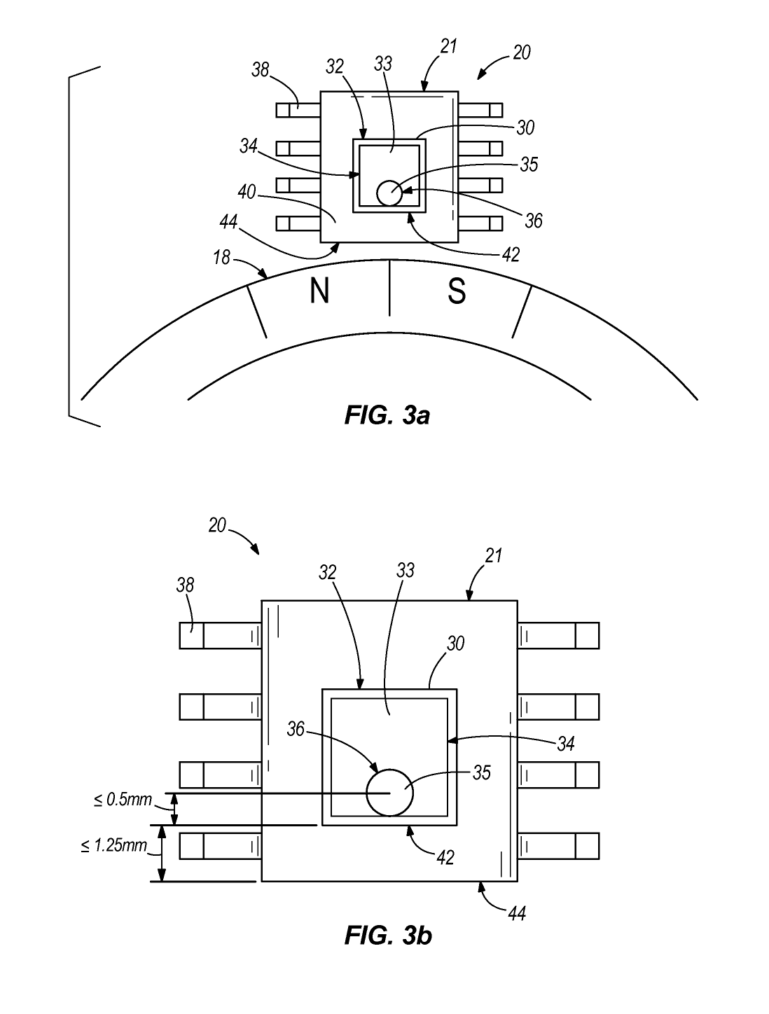

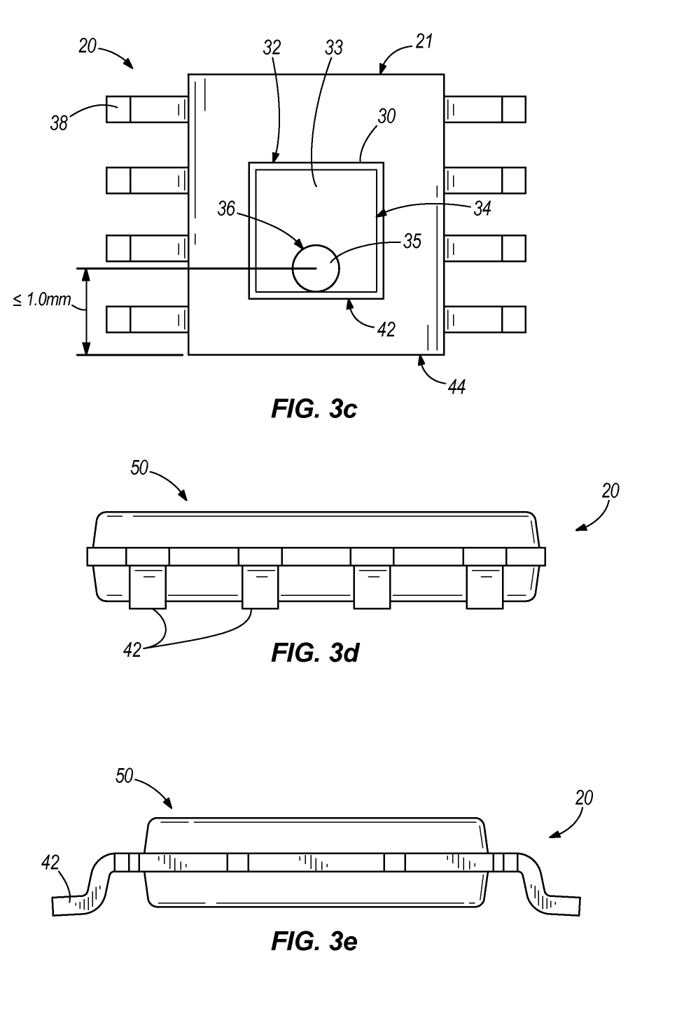

A torque angle sensor assembly 16 measures steering shaft torque by measuring the relative angle between a first and second end of the torsion bar. In particular, as illustrated in FIG. 3, the sensor assembly 16 includes a ring-shaped magnet 18 that is attached to an axial end of the input shaft 12 connected to the first end of the torsion bar. Therefore, the magnet 18 rotates with the input shaft 12 and the first end of the torsion bar.

The torque angle sensor assembly 16 also includes an electronic device 20. The electronic device 20 is positioned stationary relative to the magnet 18. Therefore, when the torsion bar twists, the magnet 18 rotates relative to the device 20. In some embodiments, the sensor assembly 16 is connected to an axial end of the output shaft 14 connected to the second end of the torsion bar. In other embodiments, the electronic device 20 is positioned concentric to the torsion bar but is not connected to the torsion bar or the output shaft 14.

As schematically illustrated in FIG. 3a, the electronic device 20 has a perimeter 21 and includes a semiconductor die 30 having a perimeter 32. A processor (such as an application specific integrated circuit (“ASIC”)) 33 is also formed in the die 30. In some embodiments, the processor 33 is formed within an active area 34 of the die 30 and, in some embodiments, consumes the entire active area 34. A magneto-resistive (“MR”) sensing element 35 having a perimeter 36 is also formed in the die 30. As illustrated in FIG. 3a, in some embodiments, the MR sensing element 35 is positioned on top of the processor 33 and is electrically connected to the processor 33 (e.g., via connections formed in the die 30). In some embodiments, the MR sensing element 25 is formed by adding additional layers (e.g., metal layers) on a small area on top of the processor 33.

In some embodiments, the MR sensing element 35 includes an anisotropic magneto-resistance (“AMR”) angle sensor. In other embodiments, MR sensing element 35 includes a giant magneto-resistance (“GMR”) angle sensor or a tunnel magneto-resistance (“TMR”) angle sensor. The MR sensing element 35 is configured to measure one or more characteristics of a magnetic field generated by the magnet 18, such as angle (or direction) and/or strength (or magnitude).

The processor 33 is configured to condition signals or data from the MR sensing element 35 into analog or digital signals that can be used to create information about an angle of the magnetic field generated by the magnet 18. In some embodiments, the processor 33 is also configured to translate information about an angle of the magnetic field into a torque applied to the input shaft 12. The processor 33 also includes circuitry for communicating magnet field angle information (or torque information) according to a predetermined communication protocol (e.g., an analog signal protocol, a pulse-width-modulated signal protocol, single edge nibble transmission signal protocol, or other voltage-based or current-modulated digital communication protocol).

Electrical connectors or pins 38 are electrically connected to the die 30, which allow the die 30 to be mounted on a printed circuit board 39 (see FIGS. 1 and 2). The semiconductor die 30 and the electrical connectors 38 are encapsulated in a non-conductive material, such as plastic, to form a monolithic package 40 that defines at least a portion of the perimeter 21 of the electronic device 20. The connectors 38, however, pass through the non-conductive material. It should be understood that although only an 8-pin package is illustrated in the figures, other packages 40 with fewer or more connectors 38 can be used.

As illustrated in FIG. 3a, the MR sensing element 35 is positioned near the perimeter 32 of the die 30, and the die 30 is positioned near the perimeter 21 of the electronic device 20, which positions the MR sensing element 35 near the perimeter 21 of the electronic device 20. In this position, the MR sensing element 35 is located near a portion 41 of the perimeter 32 and a portion 42 of the perimeter 21 that are each positioned closest to or proximate the magnet 18. As illustrated in FIG. 3, in this position, the MR sensing element 35 is positioned off-center with respect to the perimeter 21 of the device 20 and is located close to the magnet 18 during operation of the sensor assembly 16.

In particular, in some embodiments, the MR sensing element 35 is positioned such that a portion of the perimeter 36 of the MR sensing element 35 is approximately co-planar with the active area 34 of the die 30 (e.g., defined by the processor 33). The active area 34 of the die 30 is offset by a marginal distance from the perimeter 32 of the die 30 to allow for cutting of the die 30 during manufacturing. This marginal offset between the active area 34 of the die 30 and the physical perimeter 32 of the die 30 is well-established in semiconductor die manufacturing and, in some embodiments, ranges from approximately 0.5 millimeters to approximately 0.1 millimeters. In other embodiments, the MR sensing element 35 is positioned approximately co-planar with the physical perimeter 32 of the die.

Also, in some embodiments, a center of the MR sensing element 35 is positioned approximately 1.75 millimeters or less from the perimeter 21 of the electronic device 20 (i.e., a portion 42) and, in some embodiments, is positioned less than approximately 1.0 millimeter from the perimeter 21 of the electronic device 20 (i.e., a portion 44). However, as described below, other dimensions and configurations of the electronic device 20 are possible while providing an integrated package that positions an MR sensing element close to an external magnet.

In particular, FIG. 3b illustrates one configuration of the electronic device 20. As illustrated in FIG. 3b, the center of the MR sensing element 35 is located approximately 0.5 millimeters or less from the portion 42. The portion 42 is also located approximately 1.25 millimeters or less from the portion 44. In this position, the distance from the center of the MR sensing element 35 to the portion 44 is approximately 1.75 millimeters or less. In this position, the radial distance between the MR sensing element 35 and the magnet 18 is minimized, and the MR sensing element 35 is located close to the magnet 18 as the magnet 18 rotates. In other embodiments, as illustrated in FIG. 3c, the center of the MR sensing element 35 is located less than 1.0 millimeters from the portion 44.

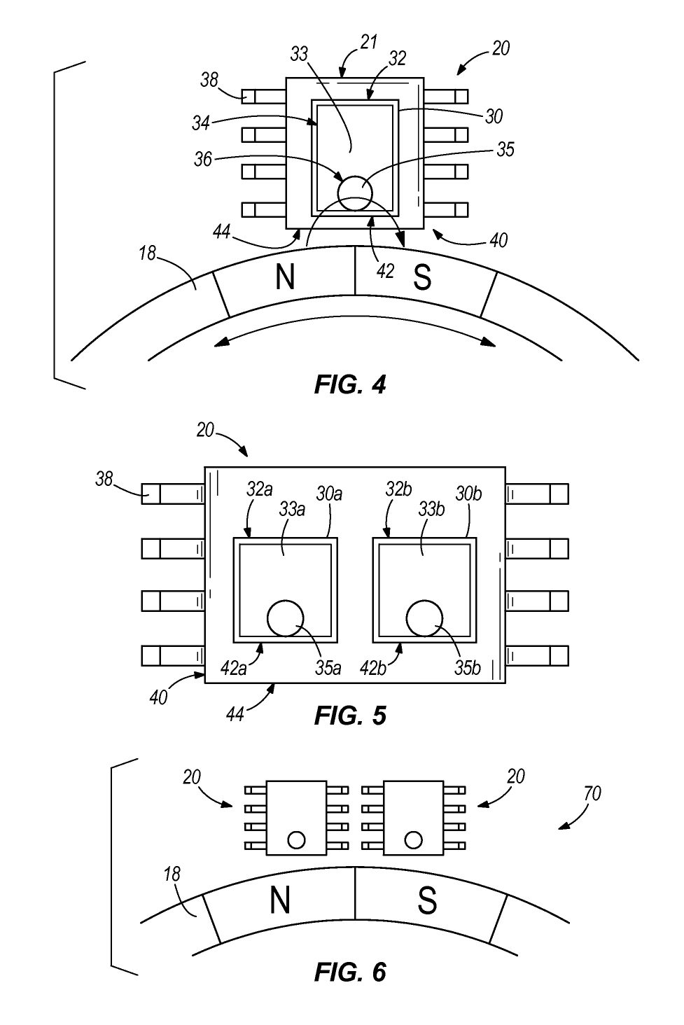

As illustrated in FIG. 4, the magnet 18 is polarized such that the magnetic field angle at the MR sensing element 35 changes as the magnet 18 rotates relative to the sensing element 35. In particular, the MR sensing element 35 is normally made of several resistive elements arranged in one or more bridge configurations. The resistance of the resistive elements and, consequently, the output of the resistive bridges, changes as the angle of the magnetic field changes at the sensing element 35. Thus, the output of the MR sensing element 35 changes when the magnet 18 rotates relative to the electronic device 20.

The monolithic package 40 improves sensing performance and decreases assembly cost of the sensor assembly 16. In particular, the package 40 reduces the number of assembly steps for the sensor assembly 16. For example, the two steps of separately installing the MR sensing element 35 and the processor 33 is replaced by the single step of installing the package 40. In addition, when the MR sensing element 35 and the processor 33 are installed separately as bare dies, they may be wire-bonded to the printed circuit board, which is a relatively expensive process because it requires a clean room environment. In contrast, the package 40 is installed using conventional surface-mount techniques, which is less expensive. In addition, other components are surface-mounted on the printed circuit board 39. Therefore, installing the monolithic package 40 on the board 39 only adds one additional placement of a surface mount component to the already existing surface-mounting assembly step. Accordingly, even if the package 40 is more expensive to produce as compared to a bare die previously used for the processor 33, the integrated package's lower assembly cost and shorter cycle time lowers the overall cost of the sensor assembly 16.

In addition, by placing the MR sensing element 35 at or near the perimeter 32 of the die 30 closest to the magnet 18 (e.g., the portion 42) and at or near the perimeter 21 of the device 20 closest to the magnet (e.g., the portion 44), the MR sensing element 35 is positioned as close as possible to the surface of the magnet 18. In this position, MR sensing element 35 is positioned within a strong part of the magnetic field generated by the magnet 18, which allows the sensing element 35 to obtain more accurate field angle readings.

Furthermore, integrating the sensing element 35 and the processor 33 in the single die 30 also reduces temperature offset effects. In particular, the offset of the MR sensing element 35 over temperature can be compensated by the processor 33.

It should be understood that in some embodiments, the electronic device 20 described above can include two MR sensing elements 35. For example, FIG. 5 schematically illustrates an alternative electronic device 20 for the torque sensor assembly 16. The electronic device 20 includes a first MR sensing element 35a formed in a first die 30a and a second MR sensing element 35b formed in a second die 30b. A processor (such as one or more ASICs) 33a and 33b is also formed in each die 30a and 30b.

As illustrated in FIG. 5, both of the sensing elements 35a and 35b are positioned near the perimeter 32 of their respective dies 30a and 30b (i.e., portions 42a and 42b) and the dies 30a and 30b are positioned near the perimeter 21 of the device 20 (i.e., the portion 44). In some embodiments, the dies 30a and 30b are positioned side-by-side in the device 20 as illustrated in FIG. 5. In other embodiments, the dies 30a and 30b can be stacked on one another and placed in a single package. Other configurations of the MR sensing elements 35a and 35b and the dies 30a and 30b are also possible.

In some embodiments, the first MR sensing element 35a senses different magnetic properties than the second MR sensing element 35b. In other embodiments, the first and second sensing elements 35a and 35b sense the same magnetic property. In both embodiments, the first MR sensing element 35a and the second MR sensing element 35b provide a redundant sensing system. In addition, to provide a redundant sensing system that includes independent circuitry (e.g., to check the circuitry for failures in addition to the sensing elements 35a and 35b), a system or configuration 70 as shown in FIG. 6 may be used. The configuration 70 includes two electronic devices 20 placed side-by-side on a printed circuit board (as illustrated in FIG. 6). Alternatively, each package 40 could be positioned on opposite sides of a printed circuit board. The output of each package 40 can be compared (e.g., by the processor 33 or a separate processing component or system) to identify problems or failures with the packages 40.

Thus, the invention provides, among other things, a monolithic package including a MR sensing element and a processor included in a single die. The integrated configuration of the package reduces assembly costs and improves torque sensing. It should be understood that the shapes and configurations of the monolithic package and the components included in the package are provided as schematic illustrations and that other shapes and configurations are possible. For example, in some embodiments, the MR sensing element has a rectangular shape rather than a circular shape as illustrated in the figures.

Various features and advantages of the invention are set forth in the following claims.

1. An electronic device for measuring a magnetic field angle within a vehicle steering assembly, the electronic device comprising:
a semiconductor die having a perimeter;
a magneto-resistive sensing element formed in the die and located near the perimeter of the semiconductor die;
a processing circuit formed in the die and electrically connected to the magneto-resistive sensing element, the processing circuit configured to generate a signal indicative of at least one of magnetic field angle and a steering torque; and
a non-conductive material encapsulating the semiconductor die and forming a package having a perimeter;
wherein the semiconductor die is located near the perimeter of the package to position the magneto-resistive sensing element near the perimeter of the package.

2. The electronic device of claim 1, wherein the magneto-resistive sensing element includes an anisotropic magneto-resistance angle sensor.

3. The electronic device of claim 1, wherein the magneto-resistive sensing element includes at least one of a giant magneto-resistance angle sensor and a tunnel magneto-resistance angle sensor.

4. The electronic device of claim 1, wherein a perimeter of the magneto-resistive sensing element is located approximately co-planar with the perimeter of the semiconductor die.

5. The electronic device of claim 4, wherein a center of the magneto-resistive sensing element is located approximately 1.75 millimeters or less from the perimeter of the package.

6. The electronic device of claim 1, wherein a perimeter of the magneto-resistive sensing element is located approximately co-planar with a perimeter of an active area of the semiconductor die.

7. The electronic device of claim 6, wherein a center of the magneto-resistive sensing element is located approximately 1.75 millimeters or less from the perimeter of the package.

8. The electronic device of claim 1, wherein a perimeter of the magneto-resistive sensing element is located from approximately 0.5 millimeters to approximately 0.1 millimeters from the perimeter of the semiconductor die.

9. The electronic device of claim 8, wherein a center of the magneto-resistive sensing element is located approximately 1.75 millimeters or less from the perimeter of the package.

10. The electronic device of claim 1, wherein a center of the magneto-resistive sensing element is located approximately 1.75 millimeters or less from the perimeter of the package.

11. The electronic device of claim 10, wherein the magneto-resistive sensing element is located near a portion of the perimeter of the semiconductor die positioned closest to a magnet located external to the electronic device.

12. The electronic device of claim 11, wherein the magneto-resistive sensing element is located near a portion of the perimeter of the package positioned closest to a magnet located external to the electronic device.

13. The electronic device of claim 37, wherein the at least one electrical connector is configured to be surface-mounted to the printed circuit board.

14. The electronic device of claim 1, further comprising a second magneto-resistive sensing element formed on a second semiconductor die and located near a perimeter of the second semiconductor die.

15. The electronic device of claim 14, further comprising a second processing circuit formed in the second semiconductor die and electrically connected to the second magneto-resistive sensing element, the second processing circuit configured to generate a signal indicative of at least one of magnetic field angle and a steering torque

16. The electronic device of claim 14, wherein a perimeter of the second magneto-resistive sensing element is located approximately co-planar with the perimeter of the second semiconductor die.

17. The electronic device of claim 16, wherein a center of the second magneto-resistive sensing element is located approximately 1.75 millimeters or less from the perimeter of the package.

18. The electronic device of claim 14, wherein a perimeter of the second magneto-resistive sensing element is located approximately co-planar with a perimeter of an active area of the second semiconductor die.

19. The electronic device of claim 18, wherein a center of the second magneto-resistive sensing element is located approximately 1.75 millimeters or less from the perimeter of the package.

20. The electronic device of claim 14, wherein a perimeter of the second magneto-resistive sensing element is located from approximately 0.5 millimeters to approximately 0.1 millimeters from the perimeter of the second semiconductor die.

21. The electronic device of claim 20, wherein a center of the second magneto-resistive sensing element is located approximately 1.75 millimeters or less from the perimeter of the package.

22. The electronic device of claim 14, wherein a center of the second magneto-resistive sensing element is located approximately 1.75 millimeters or less from the perimeter of the package.

23. The electronic device of claim 22, wherein the second magneto-resistive sensing element is located near a portion of the perimeter of the second semiconductor die positioned closest to a magnet located external to the electronic device.

24. The electronic device of claim 23, wherein the second magneto-resistive sensing element is located near a portion of the perimeter of the package positioned closest to a magnet located external to the electronic device.

25. The electronic device of claim 14, wherein the second semiconductor die is positioned adjacent the first semiconductor die.

26. The electronic device of claim 14, wherein the second semiconductor die is stacked on the first semiconductor die.

27. A sensor assembly for measuring a magnetic field angle within a vehicle steering assembly, the sensor assembly comprising:
a first electronic device as claimed in claim 1; and
a second electronic device as claimed in claim 1, wherein second electronic device is positioned adjacent the first electronic device on the printed circuit board.

28. A sensor assembly for measuring the relative angle between first and second shafts of a vehicle steering assembly, the sensor assembly comprising:
a magnet coupled to the first shaft;
an electronic device as claimed in claim 1 coupled to the second shaft, wherein the magneto-resistive sensing element is located near a portion of the perimeter of the semiconductor die positioned closest to the magnet and is located near a portion of the perimeter of the package positioned closest to the magnet.

29. The sensor assembly of claim 28, wherein the magneto-resistive sensing element includes at least one of an anisotropic magneto-resistance angle sensor, a giant magneto-resistance angle sensor, and a tunnel magneto-resistance angle sensor.

30. The sensor assembly of claim 29, wherein a perimeter of the magneto-resistive sensing element is located approximately co-planar with the perimeter of the semiconductor die.

31. The sensor assembly of claim 30, wherein a center of the magneto-resistive sensing element is located approximately 1.75 millimeters or less from the perimeter of the package.

32. The sensor assembly of claim 29, wherein a perimeter of the magneto-resistive sensing element is located from approximately 0.5 millimeters to approximately 0.1 millimeters from the perimeter of the semiconductor die.

33. The sensor assembly of claim 32, wherein a center of the magneto-resistive sensing element is located approximately 1.75 millimeters or less from the perimeter of the package.

34. The sensor assembly of claim 29, wherein a perimeter of the magneto-resistive sensing element is located approximately co-planar with a perimeter of an active area of the semiconductor die.

35. The sensor assembly of claim 34, wherein a center of the magneto-resistive sensing element is located approximately 1.75 millimeters or less from the perimeter of the package.

36. The electronic device of claim 1, further comprising at least one electrical connector connected to the die, passing through the non-conductive material encapsulating the semiconductor die.

37. The electronic device of claim 1, wherein the at least one electrical connector is configured to be electrically connected to a printed circuit board.
